(19) United States
(12) Patent Application Publication
(10) Pub. No.: US 2013/0078441 A1
(43) Pub. Date: Mar. 28, 2013

(54) SUBSTRATE FOR AN OPTICAL FILM STACK

(71) Applicants: James Elmer Abbott, JR., Albany, OR (US); Todd A. Berdahl, Corvallis, OR (US); Stephan R. Clark, Albany, OR (US)

(72) Inventors: James Elmer Abbott, JR., Albany, OR (US); Todd A. Berdahl, Corvallis, OR (US); Stephan R. Clark, Albany, OR (US)

(21) Appl. No.: 13/247,992

(22) Filed: Sep. 28, 2011

(51) Int. Cl. G02B 1/10; B32B 27/06; B32B 7/02; G02B 1/11; B05D 5/06

(52) U.S. Cl. 428/215; 359/586; 427/162; 428/336

(57) ABSTRACT

A substrate for an optical film stack is disclosed herein. A method of preparing a substrate for an optical film stack includes placing a polymer base material in a vacuum chamber, the polymer base material having a glass transition temperature (T_{g}) that is lower than a deposition temperature of an optical film layer to be deposited on the substrate to form the optical film stack. The method further includes depositing a capping layer on the polymer base material, the depositing taking place at a temperature that is less than or equal to 10% above the T_{g} of the polymer base material.

### BACKGROUND

The present disclosure relates generally to substrates for an optical film stack.

Optical film stacks may be used in a variety of applications. As examples, optical film stacks may be of use on cover materials; in multi-color or monochromatic displays (e.g., electrokinetic displays); as protective coatings over optical surfaces (such as mirrors, lenses, windows, etc.); or directly as an optical surface for reflection or transmission or both reflection and transmission. In at least some of these applications, it may be desirable to create the optical film stack on a polymer base material. This may be desirable, for example, in terms of cost, flexibility, mechanical properties, or the like. An optical film stack on a polymer base material may be used, for example, as an anti-reflective coating for use in a reflective display. This enables desirable optical performance of the reflective display by allowing more light to pass into and reflect from the active material or surface.

### BRIEF DESCRIPTION OF THE DRAWINGS

Features and advantages of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a cross-sectional view of a schematic illustration of an example of an optical film stack including an example of a substrate and an example of a plurality of optical film layers;

FIG. 2 is a flow diagram showing a method of preparing an example of a substrate for an example of an optical film stack; and

FIG. 3 is a graph depicting a relationship between percent reflectance and wavelength for a glass substrate (solid line), and for a substrate (dotted line) including polyethylene terephthalate (PET) as a base material with a capping layer deposited thereon as part of an optical film stack.

### DETAILED DESCRIPTION

Optical film layers are often built upon substrates in order to create an optical film stack. The examples disclosed herein introduce a capping layer to the polymer base material, where the capping layer is present between the polymer base material and the optical film layer(s). Examples of the optical stack disclosed herein may be suitable for use in multiple applications, including displays, lenses, windows, or other optical surfaces. In an example, the substrate including the capping layer is utilized with optical film layer(s) that is/are designed to act as an anti-reflective coating. This application may be particularly useful for eyeglass and/or window treatments, and for displays (e.g., electrokinetic displays).

As used herein, the term “substrate” refers to the polymer base material and the capping layer. The “optical film layer(s)” are any layers that are deposited onto the capping layer. Together, the substrate and the optical film layer(s) are referred to as the “optical film stack”. While the capping layer is considered to be part of the substrate, it is to be understood that the capping layer may have a property or properties that function in conjunction with the function(s) of the optical film layer(s). For example, the capping layer may contribute to the reflective or anti-reflective property of the optical film layer(s). As such, in the examples of the optical film stack disclosed herein, the capping layer may be considered part of the substrate and also one of the optical film layers.

Typically, a stack of high quality, optical films or layers has been formed directly on a flexible polymer base material. In some cases, the deposition of the optical film layer(s) on the base material is performed at a deposition temperature that is higher than the glass transition temperature (T_{g}) of the polymer base material. The conditions often used to deposit the optical film layer(s) may lead to a deposition temperature that is relatively high with respect to the T_{g} of the polymer base material. For example, the evaporation temperature of some standard dielectrics (e.g., which may be used in the optical film stack) leads to higher deposition temperature(s) of those dielectrics, which may be higher than the T_{g} of the polymer base material that is used. This/these deposition temperature(s) may lead to an increase in the temperature of the polymer base material above the T_{g} of the polymer base material during deposition. High deposition temperature(s) may also be desirable in order to form dense, and thus more robust, optical film layer(s).

It has been found, however, that the heat produced during deposition of the optical film layer(s) may, in some cases, lead to outgassing of the underlying polymer base material, which can potentially contaminate the thin optical film layer(s) during deposition. Outgassing may involve the evolution/release of materials (e.g., volatile organic and/or inorganic gases) from the polymer base material 12 due to elevated temperatures, and these materials may degrade the deposited optical film layer(s). For instance, in a typical scenario, some materials used to form an optical film layer release high amounts of energy (kJ/mol) during the formation of the layer. Since the temperature of the polymer base material is dependent on the rate of deposition of the optical film layer(s) and the energy released during the formation of the layer(s), an increase in the temperature of the polymer base material will likely occur during deposition. Generally, a higher rate of deposition results in a higher rate of energy imparted to the polymer base material, and thus an increase in the temperature of the polymer base material during deposition of the optical film layer(s). Since outgassing of the polymer base material generally occurs at the higher temperatures, there is a higher chance, in these instances, that the optical film layer(s) may be contaminated, which may deleteriously affect their optical properties and ultimately the performance of the device employing the polymer base material and the optical film layer(s).

The inventors of the present disclosure have found that contamination of the deposited optical film layer(s) due, at least in part, to the outgassing of the underlying polymer base material during deposition may be reduced, or even eliminated, by introducing a capping layer into the optical film stack.

The capping layer disclosed herein renders the substrate suitable for non-deleterious formation of optical film layer(s) at an optical film layer deposition temperature that is above 10% above the T_{g} of the polymer base material. It is noted that not all of the optical film layer(s) used will necessarily be deposited at this higher temperature. For example, SiO₂ may be used as one of the optical film layer(s) as well as being used as the capping layer, and its deposition temperature is not more than 10% above the T_{g} of the polymer base material. However, at least one of the optical film layer(s) that may be desirable for the optical film stack may have a deposition temperature that is above 10% above the T_{g} of the polymer base material. The introduction of the capping layer enables this type of optical film layer to be deposited without the destruction of the optical layer's structural and/or optical integrity due, at least in part, to the fact that the capping layer acts as a barrier to polymer base material outgassing. As such, by “non-deleterious formation”, it is meant that the optical film layer(s) are protected from outgassing while they are being deposited at an optical film layer deposition temperature that is above 10% above the T_{g} of the polymer base material, and that the optical properties of the deposited optical film layer(s) remain intact after the optical film layer(s) are deposited.

The capping layer may be formed directly on a surface of the polymer base material, and the optical film layer(s) of the stack may be formed on the capping layer. In this configuration, the capping layer acts as a barrier to organic and/or inorganic gases emitted by the polymer base material when heated to more than 10% above the glass transition temperature (T_{g}) of the polymer base material. Further, the capping layer may be selected from a material that will contribute to the optical property/ies of the optical film stack.

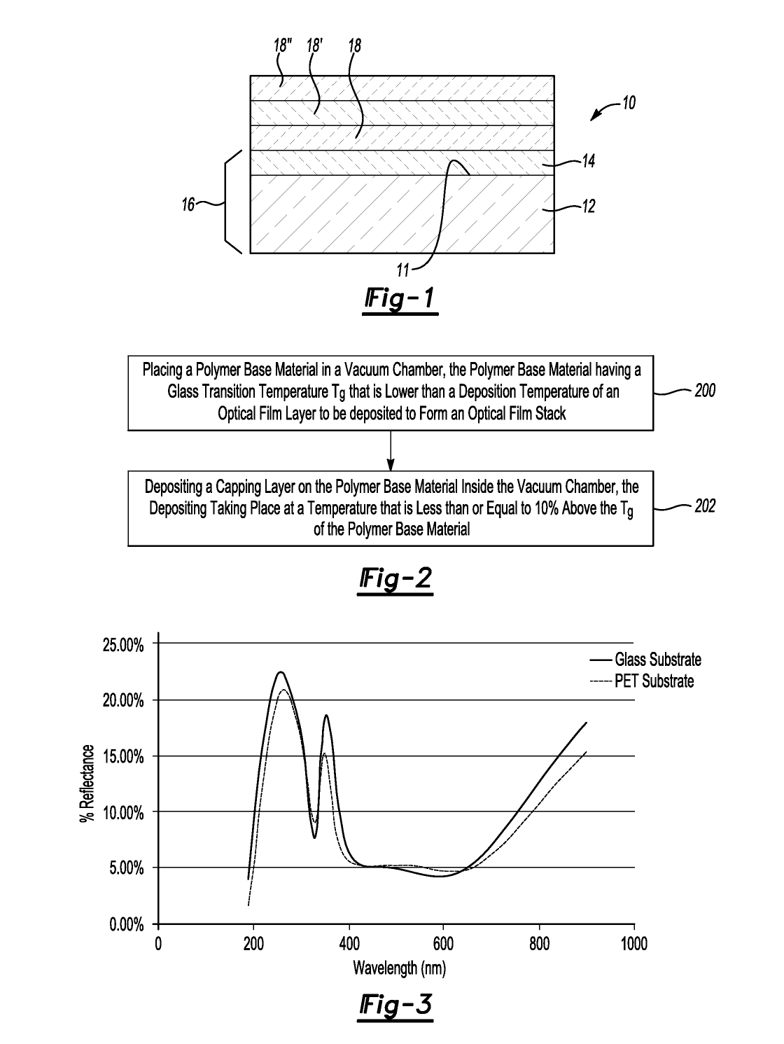

An example of an optical film stack is schematically shown in FIG. 1. The optical film stack 10 includes a substrate 16 that is prepared by depositing a capping layer 14 onto a surface (e.g., the surface 11) of a polymer base material 12. The optical film stack 10 further includes one or more optical film layers (e.g., layers 18, 18′, 18″) deposited on the substrate 16. As shown in the example depicted in FIG. 1, the optical film stack 10 includes three optical film layers, where one layer 18 is deposited on the capping layer 14 of the substrate 16, the next layer 18′ is deposited on the layer 18, and the outer-most layer 18″ is deposited on the layer 18′. It is to be understood that the optical film stack 10 may have any number of optical film layers 18, 18′, 18″, etc., such as a single optical film layer, two optical film layers, five optical film layers, etc. Further details of the optical film layers 18, 18′, 18″ will be provided below.

The polymer base material 12 may be chosen from any polymer that can be formed into a flexible thin film or sheet that is usable as an optical element in a display or other device requiring a specifically designed optical performance (e.g., eyeglasses, windshields, windows, etc.). In an example, the polymer base material 12 has a thickness ranging from about 5 μm to about 10 mm. In an example in which the optical stack 10 is utilized in a reflective display, the polymer base material 12 may have a thickness ranging from about 5 μm to about 2 mm. It is to be understood that the flexibility will depend, at least in part, upon the polymer selected for the polymer base material 12, the overall size of the polymer base material 12, and the thickness of the polymer base material 12.

The polymer base material 12 is also chosen from a polymer having a glass transition temperature T_{g} that is lower than the deposition temperature of at least one of the optical film layer(s) (e.g., 18, 18′, 18″) to be deposited on the substrate 16 to form the optical film stack 10. In an example, the T_{g} of the polymer base material 12 ranges from about 30° C. to about 215° C., and in another example, the T_{g} of the polymer base material 12 ranges from about 30° C. to about 150° C. In yet another example, the T_{g} of the polymer base material 12 ranges from about 60° C. to about 90° C. Any suitable polymer having the desired T_{g} may be selected for the polymer base substrate 12. Examples of polymers that may be used for the polymer base material 12 include polyvinyl acetate, polyethylene terephthalate (PET), polyethylene naphthalate (PEN), polyester, polyvinyl chloride, polyvinyl alcohol, polystyrene, polymethyl methacrylate, polycarbonate, polynorborene, and mixtures thereof. In an example, the polymer base material 12 is chosen from polyethylene terephthalate, polyethylene naphthalate, and polyester.

The capping layer 14 is a thin film layer that is deposited directly onto, e.g., the surface 11 of the polymer base material 12. The capping layer 14 has a number of properties, including: i) can be deposited at a temperature that ranges from room temperature (e.g., 18° C. to about 25° C.) to 10% above the T_{g} of the polymer base material that is selected, ii) can be deposited in a vacuum deposition chamber, iii) is a barrier to organic and/or inorganic gases emitted by the polymer base material when heated to more than 10% above its T_{g}, iv) is thin, and v) has consistent optical properties (e.g., reflection, anti-reflection, etc.) before and after the deposition process. Examples of materials that may be used for the capping layer 14 include SiO₂, SiO, MgF, Al₂O₃, TiO₂, Nb₂O₅, and HfO₂. Selection of the capping layer material will depend, at least in part, on the selected polymer base material 12. For example, TiO₂ may not be suitable as the capping layer 14 when PEN or PET is selected for the polymer base material 14. This is due, at least in part, to the respective T_{g}s of PEN and PET and the deposition temperature of TiO₂ when deposition is performed in an evaporator. As will be discussed further hereinbelow, the deposition parameters may be altered in order to achieve deposition of one or more of these materials within the defined temperature range.

As used herein, the term “thin” when used in reference to the capping layer 14 refers to a layer having a thickness ranging from about 10 nm to about 85 nm. In another example, the thin film capping layer 14 has a thickness ranging from about 10 nm to about 35 nm. It is believed that the thickness of the capping layer 14 disclosed herein is particularly desirable, at least in part, because such thicknesses provide protection during deposition while not interfering with the optical properties of the overall optical stack 10. It is believed that the capping layer 14 should have a minimum thickness of about 10 nm, at least in part because, at and above this minimum thickness, the capping layer 14 can i) suitably protect subsequently deposited optical film layer(s) on the substrate 16 from contamination, and ii) exhibit desirable optical properties that will contribute to the optical film stack 10. For instance, the thickness of the capping layer 14 may depend, at least in part, on the desired optical property to be exhibited by the capping layer 14 relative to the other optical film layer(s) 18, 18′, 18″ of the optical film stack 10. Different optical properties, such as transmission and reflectance, may, for instance, be achieved by varying the thicknesses of one or more of the optical film layers 18, 18′, 18″, including the capping layer 14. For example, a percent reflectance of, e.g., 0.2% to 0.4% may be achieved at a desired wavelength range (e.g., between 500 nm and 600 nm) with an optical film stack 10 that includes i) SiO₂ as a capping layer 14 having a thickness of about 35 nm, ii) TiO₂ as an optical film layer (e.g., 18) formed on the capping layer 14 and having a thickness of about 14 nm, iii) SiO₂ as an optical film layer (e.g., 18′) formed on the TiO₂ optical film layer and having a thickness of about 29 nm, iii) TiO₂ as yet another optical film layer (e.g., 18″) formed on the SiO₂ optical film layer and having a thickness of about 114 nm, and iv) SiO₂ as still another (e.g., the outer-most) optical film layer formed on the second TiO₂ optical film layer and having a thickness of about 89 nm.

It is believed that the thickness of the capping layer 14 may be varied depending on the desired optical property/ies for the optical film stack 10. The capping layer thickness may depend, in some instances and at least in part, on the deposition time, deposition cost, and stress factors.

The capping layer 14 may be chosen from a material that exhibits an optical property that may contribute to the optical properties of the film stack 10, as well as from a material that acts as a barrier and that is capable of being deposited (via a low pressure vacuum deposition technique) on the polymer base material 12 at a temperature that can be above, but near, or below the T_{g} of the polymer base material 12. In an example, the material for the capping layer 14 is any material that can be deposited on the polymer base material 12 at a temperature that ranges from room temperature (i.e., from 18° C. to about 25° C.) to 10% above the T_{g} of the polymer base material 12. At this deposition temperature, it is believed that the capping layer 14 may be suitably deposited without deleteriously affecting the underlying polymer base material 12 (e.g., its integrity) and/or without deleterious amounts of outgassing from the polymer base material 12 during the deposition (i.e., outgassing is minimal and/or is reduced compared to the outgassing that results when temperatures higher than 10% above the T_{g} of the polymer base material are used). In some instances, the capping layer 14 may be selected from a material that can be deposited on the polymer base material 12 at a temperature that is greater than 10% above the T_{g} of the polymer base material 12. It has been found, however, that deposition of the capping layer 14 at a temperature that is greater than 17% above the T_{g} of the polymer base material 12 does not work, at least in part because the high temperature may deleteriously affect the polymer base material 12 and/or outgassing may occur at a level that causes degradation of the capping layer 14 that is being deposited. In another example, the capping layer 14 material is selected from a material that is capable of being deposited at a temperature that is less than about 2% above the T_{g} of the polymer base material 12.

As mentioned above, the capping layer 14 enables additional optical film layer(s) 18, 18′, 18″ to be deposited onto the polymer base material 12 at any deposition temperature, including deposition temperatures that are higher than the deposition temperature of the capping layer 12 (i.e., that are higher than 10% above the T_{g} of the polymer base material 12).

It has been found that a dichroic optical film stack may be created using a combination of higher and lower index of refraction films (e.g., as the capping layer 14 and/or the optical film layer(s) 18, 18′, 18″). In an example, the “higher” and “lower” indices of refraction of the films are relative to one another, where one film has a higher index of refraction than the other film. As previously mentioned, the refractive index of the capping layer 14 and the other optical film layer(s) 18, 18′, 18″ may be selected to create a dichroic optical film stack. Alternatively, the refractive index of the various optical film layers 18, 18′, 18″ may be selected to create the dichroic optical film stack. In an example, the material for the capping layer 14 may be selected from a substance that produces a film on the polymer base material 12 and has an index of refraction that may be greater than 1 and less than 2. Examples of such substances include SiO₂, SiO, MgF, and Al₂O₃. The material for the capping layer 14 may otherwise be chosen from other substances that also produce a film on the polymer base material 12, but have an index of refraction that may be equal to or greater than 2 and less than 6. Examples of these other substances include TiO₂, Nb₂O₅, and HfO₂. These examples of the refractive index are illustrative, and it is to be understood that the refractive index of the capping layer 14 and/or the other optical film layer(s) 18, 18′, 18″ may be selected to be higher or lower than the examples provided. For example, it may be desirable to include optical film layer(s) 18, 18′, 18″ formed of metals (Al, Ta, Ag, Au, or other single element metal films) or metalloid materials (e.g., Si) or alloys thereof (e.g., TaAl).

While a single capping layer 14 is shown, it is to be understood that a multi-layer capping layer 14 may be utilized. A multi-layer capping layer 14 may include two or more layers of different materials that are suitable capping layer materials. For example, two layers of a multi-layer capping layer 14 may have different refractive indexes, which may be selected to obtain a desired optical performance. As an example of this, one layer of a multi-layer capping layer may have an index of refraction that may be greater than 1 and less than 2, and another layer of the multi-layer capping layer may have an index of refraction that may be equal to or greater than 2 and less than 4. In another example, the multi-layered capping layer 14 may be selected to contribute to the creation of a dichroic optical film stack.

The optical film layer(s) (e.g., layers 18, 18′, 18″ shown in FIG. 1) are chosen from any suitable optical film forming material, such as, e.g., SiO₂, TiO₂, other dielectric materials, metals, metalloid materials, or any other material having a desirable optical property for the stack 10. It has been found that the optical film layer(s) 18, 18′, 18″ that have a deposition temperature above 10% of the T_{g} of the selected polymer base material 12 may be deposited on the substrate 16 despite their high deposition temperatures, at least in part because of the presence of the capping layer 14. In other words, the capping layer 14 enables deposition of a variety of the optical film layers 18, 18′, 18″, including those that are deposited at a deposition temperature that is at or below the deposition temperature used for the capping layer 14, and those that are deposited at a deposition temperature that is higher than the deposition temperature used for the capping layer 14 (i.e., is above 10% above the polymer base material T_{g}).

An example of a method for preparing the substrate 16 upon which the optical film layer(s) (e.g., layers 18, 18′, 18″) is/are deposited will now be described herein in reference to FIG. 2. The method includes placing the polymer base material 12 into a vacuum chamber (as shown by reference numeral 200). Inside the vacuum chamber, a pump is used to reduce the pressure inside the chamber for a period of time. In an example, the pressure inside the chamber is reduced to a pressure ranging, e.g., from about 1 mTorr to about 200 mTorr for about 20 minutes. At this pressure, the polymer base material 12 is at least partially degassed, which involves the removal of most, if not all of water and/or air from the polymer base material 12.

After at least partial degassing of the polymer base material 12, the method further includes depositing the capping layer 14 on the polymer base material 12 (as shown by reference numeral 202). As previously mentioned, deposition of the capping layer 14 is accomplished at a temperature that ranges from room temperature to less than about 10% above the T_{g} of the polymer base material 12, and in another example, to less than about 2% above the T_{g} of the polymer base material 12. At these deposition temperatures, it is believed that outgassing of the polymer base material 12 is minimized during the deposition of the capping layer 14 and during subsequent depositions due to the presence of the capping layer 14, which aids in preventing contamination of the layer(s) 18, 18′, 18″.

Deposition of the capping layer 14 may be accomplished via a number of different low pressure vacuum deposition techniques. Low pressure vacuum deposition techniques may be performed at a variety of different pressures; however, the pressure used in each technique is at least an order of magnitude below atmospheric pressure using the Torr pressure scale. In one example, physical vapor deposition via sputtering or evaporation inside the vacuum chamber may be used to deposit the capping layer 14 on the polymer base material 12. Other methods of depositing the capping layer 14 include chemical vapor deposition (CVD), plasma enhanced chemical vapor deposition (PECVD), and/or atomic layer deposition (ALD).

It may, in some instances, be possible to control parameters during deposition of the capping layer 14 occurring at step 202. Controlling the parameters may help in further minimizing the outgassing of the polymer base material 12, and in controlling the properties of the capping layer 14 (e.g., index of refraction, thin film stress, and the others).

One way of controlling the parameters during deposition of the capping layer 14 includes decreasing the deposition temperature for depositing the capping layer 14 on the polymer base material 12. This may be accomplished, e.g., by actively cooling the polymer base material 12. Active cooling may be accomplished, e.g., by providing a cooling mechanism inside the vacuum chamber that is on or adjacent to a back side of the polymer base material 12 (i.e., at the surface opposed to the surface 11 upon which the capping layer 14 is to be deposited). In an example, the back side of the polymer base material 12 is attached to a mounting surface in the deposition tool (e.g., vacuum chamber), and this mounting surface may be cooled. Cooling of the mounting surface may be achieved via water or another coolant flowing through a heat exchanger in the mounting surface. Additional gas flow may be provided between the mounting surface and the polymer base material 12 to improve heat transfer from the polymer base material 12 to the mounting surface, which further enhances cooling of the polymer base material 12. In an example, the polymer base material 12 is cooled to the extent that the temperature of the base material 12 does not exceed the T_{g} of the base material 12 by more than about 10% above the T_{g}. In an example where deposition is performed using a tool capable of depositing on a continuous web of material, the polymer base material 12 may be cooled by being in contact with a surface in the tool that is cooled by any of the previously mentioned methods.

Another method of controlling parameters during the deposition of the capping layer 14 involves decreasing an amount of energy imparted to the polymer base material 12 during the deposition. The amount of energy may be decreased, for example, by decreasing a rate of condensing of the capping layer material during deposition. For instance, chemical bonds may form during the deposition of the capping layer 14, and the formation of the chemical bonds increases the energy imparted to the system. Also during the deposition process, condensation reaction(s) may occur (e.g., SiO₂ molecules may condense on the surface of the polymer base material 12 during deposition of a SiO₂ capping layer 14), which increases the energy imparted to the system. As an example, transitioning SiO₂ from the gas phase to a solid phase releases about 353 kJ/mol during the condensation reaction which takes place during an evaporation deposition process. In general, the rate of condensation is related to the rate of material being deposited onto the polymer base material 12. For example, the rate of deposition and condensation may be increased in an evaporation system by changing deposition parameters, such as, by increasing the deposition source temperature to increase evaporation, decreasing pressure in the vacuum chamber, moving the deposition substrate closer to the evaporation sources, as well as other techniques.

The amount of energy imparted to the polymer base material 12 may also be decreased by decreasing a rate of a reaction that forms the capping layer 14 on the polymer base material 12. This reaction rate may be chemical in nature, e.g., the formation of chemical bonds, or physical in nature, e.g., condensation. This rate of the reaction may be decreased, for example, by decreasing the amount of power imparted to the system during deposition of the capping layer 14, which in turn effectively decreases the amount of capping layer material that is delivered to the polymer base material 12. In some cases, the amount of energy imparted may also be decreased by depositing a smaller amount of the capping layer 14 material onto the polymer base material 12. Since a smaller amount of material is available for reaction on the polymer base material 12, a smaller amount of material actually reacts. This, in turn, decreases the reaction rate of the deposition of the capping layer 14 material. For instance, it has been found that the deposition rate may be decreased from 63 angstroms/second to 11 angstroms/second by decreasing the amount of power supplied for deposition from 8 kW to about 2 kW.

Further, it has been found that a decrease in the amount of power imparted to the system depends, at least in part, on the type of material to be deposited and the method of power delivery. For example, a DC powered aluminum deposition generally requires less power for a given deposition rate than a Radio Frequency (RF) powered SiO₂ film deposition. This difference is related, at least in part, to the different bonding for the different materials and the differences in how the power is delivered to the system. The stronger the chemical bonding in the target material (i.e., the capping layer 14), the higher the energy required to break the chemical bonds at the source for deposition. In general, RF power delivery results in a lower deposition rate for a given film than DC power delivery for a given power.

In another example, the amount of energy imparted to the polymer base material 12 may be decreased by decreasing a particle bombardment on the polymer base material 12 (i.e., when particles of the capping layer material, ions, atoms, or molecules impact the polymer base material 12 during deposition, the energy imparted to the polymer base material 12 increases). Particle bombardment may be generally decreased, for example, by decreasing the power imparted to the deposition source, decreasing the voltage bias of the deposition substrate, decreasing ion beam intensity, and other methods commonly employed in vacuum deposition processes.

Yet another method of decreasing the amount of energy imparted to the polymer base material 12 is to decrease a radiation heat transfer from plasma or melted source material during an evaporation deposition process. The radiation heat transfer can be decreased by decreasing the temperature of the plasma or evaporation source, or by moving the polymer base material 12 away from the radiation sources (i.e., increasing the distance between the material 12 and the radiation sources).

Further, the deposition rate of the capping layer material onto the polymer base material 12 may be affected by making changes to the pressure inside the vacuum chamber during deposition. It has been found, for example, that during a physical vapor deposition process, a deposition rate of the capping layer material increased from 59 angstroms/second to about 76 angstroms/second by increasing the pressure inside the vacuum chamber from about 2 mTorr to about 20 mTorr, while all other deposition parameters were held constant. The pressure inside the vacuum chamber may be controlled, for instance, by changing a gas flow into the chamber, and changing the rate of vacuum pumping. It is to be understood that other pressure ranges may lead to a response in deposition rate that is opposite to the response illustrated in the previous example.

As previously mentioned, the substrate 16 may be used as a substrate for an optical film stack 10 that is usable, for example, as an optical element in a variety of different systems. In this way, the optical film stack 10 may exhibit reflective optical properties or anti-reflective optical properties, depending on how the optical film stack 10 is configured. As an example, the property/properties of the optical film stack 10 may be achieved by varying the number and/or thickness of the layers 14, 18, 18′, 18″ in the optical film stack 10 to tune the performance for either reflective or anti-reflective properties for a given set of optical materials. In an example, the optical film stack 10 has a maximum index of refraction that is less than or equal to 6 over a wavelength range of about 180 nm to about 1500 nm. However, it is to be understood that it is possible to incorporate a film/layer into the optical film stack 10 with an index of refraction much larger than 6 for the given wavelength range.

Further, it has been found that the examples of the substrate 16 disclosed herein may be used as a substrate to produce an optical coating that optically performs as well as an optical coating, of similar design, created on another substrate (without a capping layer) that is not prone to outgassing, such as, e.g., glass, fused silica, and quartz. For instance, FIG. 3 is a graph showing the percent reflectance of an optical film stack on a glass substrate (solid line) and on a substrate 16 utilizing polyethylene terephthalate (PET) as the polymer base material 12 and SiO₂ as the capping layer 14 (dotted line) on the wavelength (nm). This graph shows that the performance (e.g., in terms of reflectance) of the optical film stacks prepared on the two substrates is substantially the same, especially at a wavelength range from about 400 nm to about 600 nm, where there is less than about 0.6% difference in reflectance.

It is to be understood that the ranges provided herein include the stated range and any value or sub-range within the stated range. For example, a range from about 30° C. to about 215° C. should be interpreted to include not only the explicitly recited limits of about 30° C. to about 215° C., but also to include individual values, such as 50° C., 115° C., 190° C., etc., and sub-ranges, such as from about 40° C. to about 100° C., from about 75° C. to about 128° C., etc. Furthermore, when “about” is utilized to describe a value, this is meant to encompass minor variations (up to +/−10%) from the stated value.

While several examples have been described in detail, it will be apparent to those skilled in the art that the disclosed examples may be modified. Therefore, the foregoing description is to be considered non-limiting.

What is claimed is:

1. A substrate for an optical film stack, the substrate comprising:
a polymer base material having a glass transition temperature (T_{g}) that is lower than a deposition temperature of an optical film layer to be deposited on the substrate to form the optical film stack; and
a capping layer deposited on a surface of the polymer base material, the capping layer having a thickness ranging from about 10 nm to about 85 nm, and the capping layer being a material that i) is capable of being vacuum deposited on the polymer base material at a temperature ranging from 18° C. to 10% above the T_{g} of the polymer base material, ii) is a barrier to any of organic gases or inorganic gases emitted by the polymer base material when heated to a temperature that is greater than 10% above the T_{g} of the polymer base material, and iii) has consistent optical properties before and after vacuum deposition;
wherein the capping layer renders the substrate for non-deleterious formation of any optical film layer, including the optical film layer deposited at the optical film layer deposition temperature, which is greater than 10% above the T_{g} of the polymer base material.

2. The substrate as defined in claim 1 wherein the polymer base material has a thickness ranging from about 5 μm to about 10 mm.

3. The substrate as defined in claim 1 wherein the T_{g} of the polymer base material ranges from about 30° C. to about 215° C.

4. The substrate as defined in claim 1 wherein the capping layer is chosen from SiO₂, SiO, MgF, Al₂O₃, TiO₂, Nb₂O₅, and HfO₂.

5. The substrate as defined in claim 1 wherein the capping layer has a thickness ranging from about 10 nm to about 35 nm.

6. A method of preparing a substrate for an optical film stack, comprising:
placing a polymer base material in a vacuum chamber, the polymer base material having a glass transition temperature (T_{g}) that is lower than a deposition temperature of an optical film layer to be deposited on the substrate to form the optical film stack; and
depositing a capping layer on the polymer base material, the depositing taking place at a temperature that is less than or equal to 10% above the T_{g} of the polymer base material.

7. The method as defined in claim 6, further comprising decreasing the deposition temperature for depositing of the capping layer on the polymer base material.

8. The method as defined in claim 6, further comprising decreasing an amount of energy imparted to the polymer base material.

9. The method as defined in claim 8 wherein the decreasing of the amount of energy imparted to the polymer base material is accomplished via any of:
decreasing a rate of condensing the capping material during deposition;
decreasing a rate of a reaction forming the capping material on the polymer base material;
decreasing a particle bombardment of the polymer base material; or
decreasing a radiation heat transfer from plasma or a melted source material during evaporation.

10. The method as defined in claim 6, further comprising controlling a vacuum chamber pressure during the depositing, the controlling affecting a deposition rate of the capping layer on the polymer base material.

11. The method as defined in claim 6 wherein the depositing of the capping layer includes depositing the capping layer to a thickness ranging from about 10 nm to about 85 nm.

12. The method as defined in claim 6, further comprising any of:
depositing the optical film layer on the capping layer at a temperature that is greater than 10% above the T_{g} of the polymer base material; or
depositing an other optical film layer on the capping layer at a temperature that is that equal to or less than 10% above the T_{g} of the polymer base material.

13. An optical film stack, comprising:
a substrate, including:
a polymer base material having a glass transition temperature (T_{g}) ranging from about 30° C. to about 215° C.; and
a capping layer deposited on a surface of the polymer base material, the capping layer being a material that i) is capable of being vacuum deposited on the polymer base material at a deposition temperature ranging from 18° C. to 10% above the T_{g} of the polymer base material, ii) is a barrier to any or organic gases or inorganic gases emitted by the polymer base material when heated to a temperature that is greater than 10% above the T_{g} of the polymer base material, iii) has a consistent optical property before and after the vacuum deposition, and iv) has a thickness ranging from about 10 nm to about 85 nm; and
an optical film layer deposited on the capping layer.

14. The optical film stack as defined in claim 13 wherein the capping layer i) enables the deposition of the optical film layer at a temperature that is greater than 10% above the T_{g} of the polymer base material , and ii) prevents contamination of the optical film layer by gases that outgas from the polymer base material at a temperature that is greater than 10% above the T_{g} of the polymer base material.

15. The optical film stack as defined in claim 13 wherein the optical film stack exhibits one of a reflective or an anti-reflective optical property, and wherein the optical film stack has a maximum index of refraction that is less than or equal to 6 over a wavelength range of about 180 nm to about 1500 nm.
